(19) United States
(12) Patent Application Publication
(10) Pub. No.: US 2008/0064892 A1
(43) Pub. Date: Mar. 13, 2008

(54) Palladacycles, Their Preparation and Catalytic Processes Involving Their Use as Catalyst, Especially Catalytic Carbonylation Processes

(75) Inventors: Peter Norman Preston, Edinburgh (GB); William Edward Lindsell, Edinburgh (GB); Alan Whitton, Sterlingshire (GB); Daniel Palmer, Sterlingshire (GB); Raymond Jones, Sterlingshire (GB); Robin Fieldhouse, Sterlingshire (GB)

Correspondence Address: HESLIN ROTHENBERG FARLEY & MESITI PC, 5 COLUMBIA CIRCLE, ALBANY, NY, 12203, US

(73) Assignee: HERIOT-WATT UNIVERSITY, Edinburgh (GB)

(21) Appl. No.: 11/572,821

(22) PCT Filed: Jul. 13, 2005
(86) PCT No.: PCT/GB05/02738

§ 371 Date: Sep. 27, 2007

(30) Foreign Application Priority Data
Jul. 30, 2004 (GB) 0416929.8
Jul. 30, 2004 (GB) 0416928.0
Jul. 30, 2004 (GB) 0416930.6

(51) Int. Cl. C07F 15/00

(52) U.S. Cl. 556/14

(57) ABSTRACT

The present invention relates to palladium compounds and their use as catalysts for improved catalytic processes. Specifically there is disclosed an improved catalytic carbonylation process and improved carbonylation catalysts. Catalysts in dimer form are also disclosed, as is their catalytic activity and methods of making the compounds.

The present invention relates to an improved catalytic process and to improved catalysts. In particular, the present invention relates to palladium compounds and their use as catalysts for improved catalytic processes. The invention also relates to an improved catalytic carbonylation process and improved carbonylation catalysts.

Palladium-catalysed reactions wherein C—C, C—O or C—N bonds are formed are well known to those skilled in the art. Reactions such as the Heck and Suzuki reactions are catalysed with palladium complexes such as Pd(PPh₃)₄, trans-PdCl₂ (PPh₃)₂, Pd(dibenzylidene acetone), and [Pd(OAc)₂]₃. More recently, it has been demonstrated that palladacycle catalysts exhibit increased activity when compared to the traditional catalysts, and exhibit very good thermal and air stability. An example of such a catalyst is Bedford's chloride (Aldisson et al., Chem. Commun. (1998), 2095):

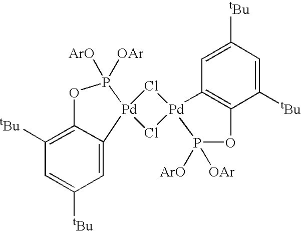

Paz Muñoz et al. (Adv. Synth. Catal. 2001, 343(4), 338-342) disclose that palladacycle dimers A and B may be used to catalyse Heck, Suzuki and Stille reactions:

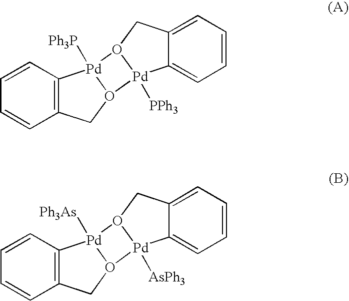

The dimers are described as “precatalysts”, probably because the exact nature of the catalytic mechanism and thus the active catalyst is unclear. For the purposes of this description, the term “catalyst” shall not be restricted to the active catalyst species, but will cover any compound (including so-called precatalysts) that can be added to a reaction mixture to promote a reaction.

As alluded to, catalysts of this type have been used in well known reactions such as Heck, Suzuki and Stille couplings. However, catalytic carbonylation reactions are known to proceed via a completely different mechanism.

US 2002/0062041 and EP 338 852 disclose that a variety of palladium catalysts can be used in carbonylation reactions. Preferred catalysts include Pd₂ dba₃ (dba is dibenzylidene acetone) and palladium complexes with phosphine ligands.

However, carbonylation reactions carried out using these known catalysts suffer from several problems and drawbacks. For example, many catalysts used in carbonylation reactions are unselective and produce a range of products, thus lowering the percent yield of the desired product. In addition, many existing catalysts produce a product that contains significant amounts of starting material, again lowering the percent yield. As the products of these reactions are mixtures, they must be purified to afford the pure desired products. However, purification is time-consuming and expensive, and can be environmentally unfriendly and labour intensive. This is especially the case when purifications are carried out on an industrial scale.

Another problem with current catalytic carbonylation procedures is that it is often necessary for them to be carried out at raised temperatures and at increased pressures. As a result, reactions of this type are complex to carry out on an industrial scale. This is especially the case when using carbon monoxide (CO) gas, which is often used in carbonylation processes. Maintaining these reaction conditions is also expensive, as they require both heat input and a pressurised reaction vessel. In addition, certain functional groups will not withstand such harsh conditions and thus reactions of this type are limited in their applications.

Therefore it would be desirable to provide further palladium compounds that can be used to catalyse C—C and C-heteroatom bond forming reactions.

Specifically, it would be desirable to provide palladium compounds that can be used to catalyse carbonylation reactions.

Therefore, it is an object of the present invention to overcome at least some of the drawbacks associated with the prior art.

Further aims and objects of the invention will become apparent from reading the following description.

According to a first aspect of the present invention there is provided a palladium compound of formula I: 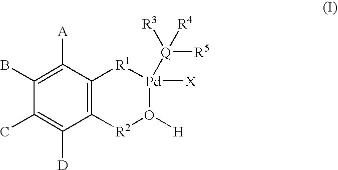
wherein A, B, C and D are independently chosen from H, alkyl, aryl, alkenyl, halo, alkoxy, dialkylamino, nitro and carbonyl-containing groups,
and/or A and B, B and C, and/or C and D together form an aromatic ring which may be optionally substituted with H, alkyl, aryl, alkenyl, halo, alkoxy, dialkylamino, nitro and carbonyl-containing groups;
R¹ and R² are independently chosen from alkylene groups that are optionally substituted with alkoxy or carbonyl-containing groups;
Q is P, As or Sb;
R³, R⁴ and R⁵ are independently chosen from aryl or alkyl groups that are optionally substituted with alkyl, aryl, dialkylamino, alkoxy or metal salts of sulfonic, carboxylic and phosphonic acids; and
X is halo, carboxylate, tosylate, mesylate or triflate.

The term “carbonyl-containing group” is used to describe R′CO— groups wherein R′ may be H, alkyl or aryl, including substituted alkyl or aryl.

A, B, C and D can be any groups that are non-reactive under catalytic reaction conditions, but are preferably all H.

R¹ and R² are straight or branched alkylene groups. They may be substituted with groups such as alkoxy, or carbonyl-containing groups such as acyl or formyl, but are preferably unsubstituted. Suitably, R¹ and R² are C₁-C₅ alkylene groups. In a preferred embodiment of the invention, R¹ and R² are both C₁ alkylene groups such that they form a six-membered ring with the Pd and the O atoms. Most preferably, R¹ and R² are CH₂.

Q is preferably P. The R³, R⁴ and R⁵ groups are suitably aryl groups or bulky alkyl groups, and are preferably phenyl, alkyl-substituted phenyl or alkoxy-substituted phenyl. Preferably R³, R⁴ and R⁵ are all the same; most preferably R³, R⁴ and R⁵ are all phenyl.

X is preferably halo, most preferably Cl or Br.

Preferred compounds according to the invention are shown as IA and IB:

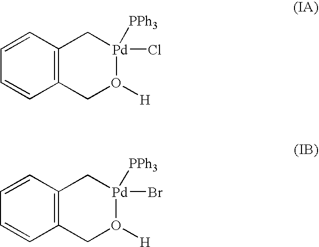

According to a second aspect of the present invention there is provided a palladium compound of formula 2I: 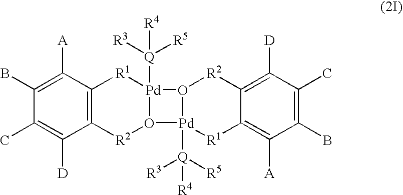
wherein A, B, C, D, R¹, R², R³, R⁴, R⁵ and Q are as defined above.

Compounds of formula 2I are essentially “dimers” formed from compounds of formula I with elimination of HX. Compounds of formula 2I are unlike the compounds disclosed by Paz Munoz et al. because the Pd is bonded to alkylene group R¹ and is not directly bonded to a benzene ring.

A, B, C and D can be any groups that are non-reactive under catalytic reaction conditions, but are preferably all H.

R¹ and R² are straight or branched alkylene groups. They may be substituted with groups such as alkoxy, or carbonyl-containing groups such as acyl or formyl, but are preferably unsubstituted. Suitably, R¹ and R² are C₁-C₅ alkylene groups. In a preferred embodiment of the invention, R¹ and R² are both C₁ alkylene groups such that they form a six-membered ring with the Pd and the O atoms. Most preferably, R¹ and R² are CH₂.

Q is preferably P. The R³, R⁴ and R⁵ groups are suitably aryl groups or bulky alkyl groups, and are preferably phenyl, alkyl-substituted phenyl or alkoxy-substituted phenyl. Preferably R³, R⁴ and R⁵ are all the same; most preferably R³, R⁴ and R⁵ are all phenyl.

Another preferred compound according to the invention is shown as 2IA:

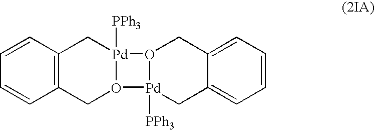

Compounds of formula I may be prepared by the reaction of readily available benzyl alcohol derivatives of formula (3I) with Pd(QR³R⁴R⁵)ₙ complexes (n=2-4). Alternatively the benzyl alcohol derivatives may be reacted with a mixture of QR³R⁴R⁵ and a suitable Pd precursor, such as Pd₂ dba₃.

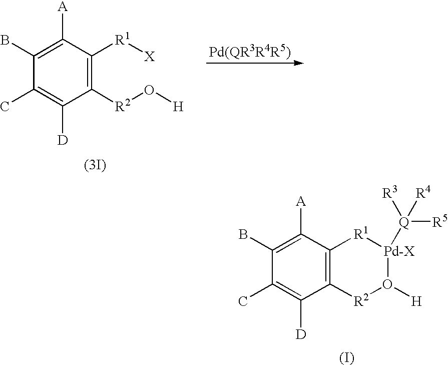

Suitable solvents for the above reaction include polar aprotic solvents such tetrahydrofuran, dioxane, diethyl ether and non-polar organic solvents such as toluene and petroleum ethers. The reaction can be carried out at room temperature or at elevated temperatures, e.g. from 50-90° C. The reaction should be carried out in an inert atmosphere, e.g. under nitrogen, to prevent significant decomposition during the reaction.

Compounds of formula 2I may be prepared by reaction of a compound of formula I with a strong base such as sodium hydride or metal alkoxides.

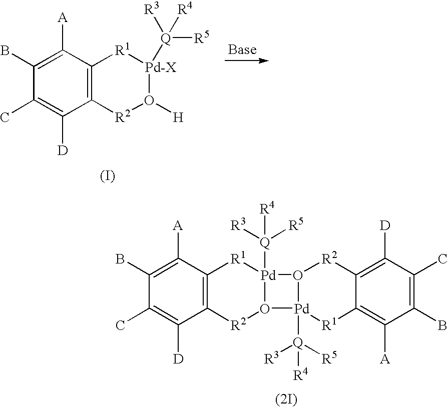

Suitable solvents for this reaction include polar aprotic solvents such as THF. The reaction may suitably be carried out at room temperature. Suitably the reaction is carried out in an inert atmosphere, e.g. under nitrogen.

According to a third aspect of the present invention there is provided a catalytic process using a compound of formula I or formula 2I as a catalyst. The catalytic process is suitably any C—C or C-heteroatom bond forming process. In a preferred embodiment, the catalytic process is a catalytic carbonylation process, e.g. 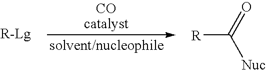
wherein R is aryl or ArCR^{a}R^{b} wherein Ar is aryl or heteroaryl and R^{a} and R^{b} are independently chosen from H, alkyl and aryl;
Lg is a leaving group such as halo, tosylate, mesylate, triflate, or carboxylate; and
Nuc is a group from the solvent or from a nucleophile that is present in the solvent, and may be OR^{c} or NR^{c}R^{d} wherein R^{c} and R^{d} are independently chosen from H, alkyl and aryl.

According to a fourth aspect of the present invention there is provided a palladium compound of formula II: 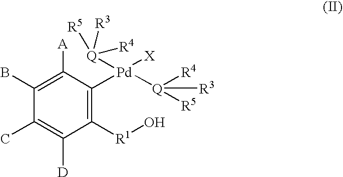
wherein A, B, C and D are independently chosen from H, alkyl, aryl, alkenyl, halo, alkoxy, dialkylamino, nitro and carbonyl-containing groups
and/or A and B, B and C, and/or C and D together form an aromatic ring which may be optionally substituted with H, alkyl, aryl, alkenyl, halo, alkoxy, dialkylamino, nitro and carbonyl-containing groups;
R¹ is a C₂-C₁₀ alkylene group that is optionally substituted with alkoxy, hydroxy or carbonyl-containing groups;
Q is P, As or Sb;
R³, R⁴ and R⁵ are independently chosen from aryl or alkyl groups that are optionally substituted with alkyl, aryl, dialkylamino, alkoxy or metal salts of sulfonic, carboxylic and phosphonic acids; and
X is halo, carboxylate, tosylate, mesylate or triflate.

A, B, C and D can be any groups that are non-reactive under catalytic reaction conditions, but are preferably all H.

R¹ is a straight or branched C₂-C₁₀ alkylene group. It may be substituted with groups such as alkoxy, or carbonyl-containing groups such as acyl or formyl, but is preferably unsubstituted. Suitably, R¹ is a C₂-C₅ alkylene group. In a preferred embodiment of the invention, R¹ is a C₂ alkylene group, most preferably, (CH₂)₂.

Q is preferably P. The R³, R⁴ and R⁵ groups are suitably aryl groups or bulky alkyl groups, and are preferably phenyl, alkyl-substituted phenyl or alkoxy-substituted phenyl. Preferably R³, R⁹ and R⁵ are all the same; most preferably R³, R⁴ and R⁵ are all phenyl.

X is preferably halo, most preferably I.

A preferred compound according to the invention is shown as IIA:

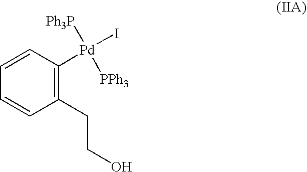

According to a fifth aspect of the present invention there is provided a palladium compound of formula 2II: 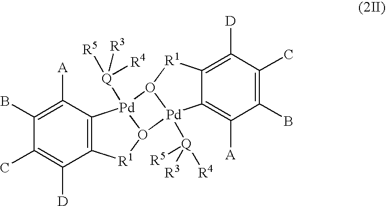
wherein A, B, C, D, R¹, R³, R⁴, R⁵ and Q are as defined above.

Compounds of formula 2II are essentially “dimers” formed from compounds of formula II with elimination of HX. Compounds of formula 2II are unlike the compounds disclosed by Paz Muñoz et al. because R¹ must have at least two carbon atoms, so the Pd atom is part of a ring with at least six members.

A, B, C and D can be any groups that are non-reactive under catalytic reaction conditions, but are preferably all H.

R¹ is a straight or branched C₂-C₁₀ alkylene group. It may be substituted with groups such as alkoxy, or carbonyl-containing groups such as acyl or formyl, but is preferably unsubstituted. Suitably, R¹ is a C₂-C₅ alkylene group. In a preferred embodiment of the invention, R¹ is a C₂ alkylene group, most preferably, (CH₂)₂.

Q is preferably P. The R³, R⁴ and R⁵ groups are suitably aryl groups or bulky alkyl groups, and are preferably phenyl, alkyl-substituted phenyl or alkoxy-substituted phenyl. Preferably R³, R⁴ and R⁵ are all the same; most preferably R³, R⁴ and R⁵ are all phenyl.

A preferred compound according to the invention is shown as 2IIA:

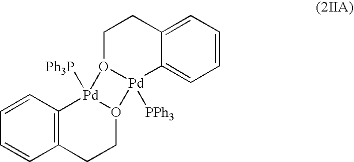

Compounds of formula II may be prepared by the reaction of readily available benzyl alcohol derivatives of formula 3II with Pd(QR³R⁴R⁵)ₙ complexes (n=2-4). Alternatively the benzyl alcohol derivatives may be reacted with a mixture of QR³R⁴R⁵ and a suitable Pd precursor, such as Pd₂ dba₃.

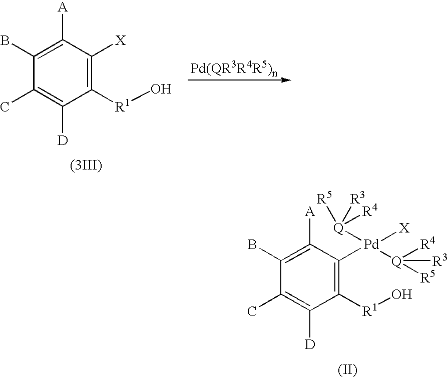

Suitable solvents for this reaction include polar aprotic solvents such tetrahydrofuran, dioxane, diethyl ether and non-polar organic solvents such as toluene and petroleum ethers. The reaction can be carried out at room temperature or at elevated temperatures, e.g. from 50-90° C. The reaction should be carried out in an inert atmosphere, e.g. under nitrogen, to prevent significant decomposition during the reaction.

Compounds of formula 2II may be prepared by reaction of a compound of formula II with a strong base such as sodium hydride or metal alkoxides.

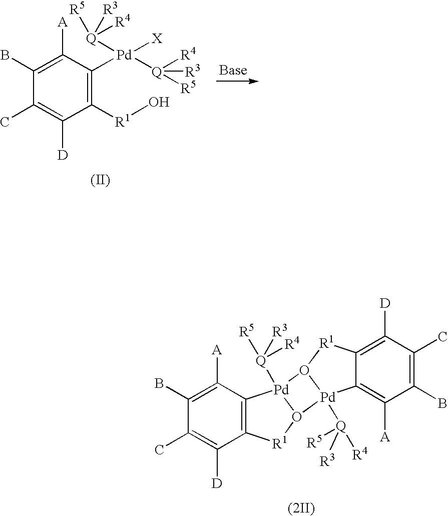

Suitable solvents include polar aprotic solvents such as THF. The reaction may suitable be carried out at room temperature. Suitably the reaction is carried out in an inert atmosphere, e.g. under nitrogen.

According to a sixth aspect of the present invention there is provided a catalytic process using a compound of formula II or formula 2II as a catalyst. The catalytic process is suitably any C—C or C-heteroatom bond forming process. In a preferred embodiment, the catalytic process is a catalytic carbonylation process, e.g. 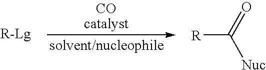
wherein R is aryl or ArCR^{a}R^{b} wherein Ar is aryl or heteroaryl and R^{a} and R^{b} are independently chosen from H, alkyl and aryl;
Lg is a leaving group such as halo, tosylate, mesylate, triflate, or carboxylate; and
Nuc is a group from the solvent or from a nucleophile that is present in the solvent, and may be OR^{c} or NR^{c}R^{d} wherein R^{c} and R^{d} are independently chosen from H, alkyl and aryl.

According to a seventh aspect of the present invention there is provided a catalytic process using a palladium compound of formula III: 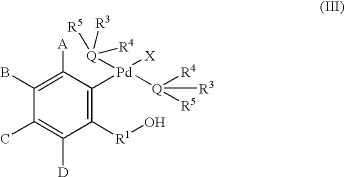
wherein A, B, C and D are independently chosen from H, alkyl, aryl, alkenyl, halo, alkoxy, dialkylamino, nitro and carbonyl-containing groups
and/or A and B, B and C, and/or C and D together form an aromatic ring which may be optionally substituted with H, alkyl, aryl, alkenyl, halo, alkoxy, dialkylamino, nitro and carbonyl-containing groups;
R¹ is a C, alkylene group that is optionally substituted with alkoxy or carbonyl-containing groups;
Q is P, As or Sb;
wherein R³, R⁴ and R⁵ are independently chosen from aryl or alkyl groups that are optionally substituted with alkyl, aryl, dialkylamino, alkoxy or metal salts of sulfonic, carboxylic and phosphonic acids; and
X is halo, carboxylate, tosylate, mesylate or triflate.

A, B, C and D can be any groups that are non-reactive under catalytic reaction conditions, but are preferably all H.

R¹ may be substituted with groups such as alkoxy, acyl or formyl, but is preferably a CH₂ group.

Q is preferably P. The R³, R⁴ and R⁵ groups are suitably aryl groups or bulky alkyl groups, and are preferably phenyl, alkyl-substituted phenyl or alkoxy-substituted phenyl. Preferably R³, R⁴ and R⁵ are all the same; most preferably R³, R⁴ and R⁵ are all phenyl.

X is preferably halo, most preferably Br or I.

Preferred compounds of formula III for use in the catalytic process are shown as IIIA and IIIB:

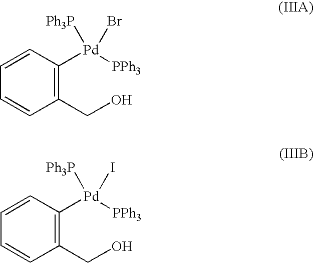

According to an eighth aspect of the present invention there is provided a catalytic process which is suitably any C—C or C-heteroatom bond forming process and is preferably a catalytic carbonylation process: 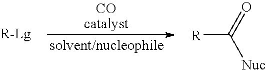
wherein R is aryl or ArCR^{a}R^{b} wherein Ar is aryl or heteroaryl and R^{a} and R^{b} are independently chosen from H, alkyl and aryl;
Lg is a leaving group such as halo, tosylate, mesylate, triflate, or carboxylate; and
Nuc is a group from the solvent or from a nucleophile that is present in the solvent, and may be OR^{c} or NR^{c}R^{d} wherein R^{c} and R^{d} are independently chosen from H, alkyl and aryl.

According to a ninth aspect of the present invention there is provided a catalytic carbonylation process using a palladium compound of formula 2III: 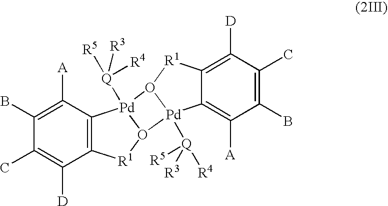
wherein A, B, C, D, R¹, R³, R⁴, R⁵ and Q are as defined above.

Compounds of formula 2III are essentially “dimers” formed from compounds of formula III with elimination of HX.

A, B, C and D can be any groups that are non-reactive under catalytic reaction conditions, but are preferably all H.

R¹ may be substituted with groups such as alkoxy, acyl or formyl, but is preferably a CH₂ group.

Q is preferably P. The R³, R⁴ and R⁵ groups are suitably aryl groups or bulky alkyl groups, and are preferably phenyl, alkyl-substituted phenyl or alkoxy-substituted phenyl. Preferably R³, R⁴ and R⁵ are all the same; most preferably R³, R⁴ and R⁵ are all phenyl.

A preferred compound for use in the catalytic carbonylation is shown as 2IIIA:

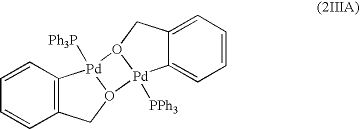

Compounds of formula III may be prepared by the reaction of readily available benzyl alcohol derivatives with Pd (QR³R⁴R⁵)ₙ complexes (n=2-4). Alternatively the benzyl alcohol derivatives may be reacted with a mixture of QR³R⁴R⁵ and a suitable Pd precursor, such as Pd₂ dba₃.

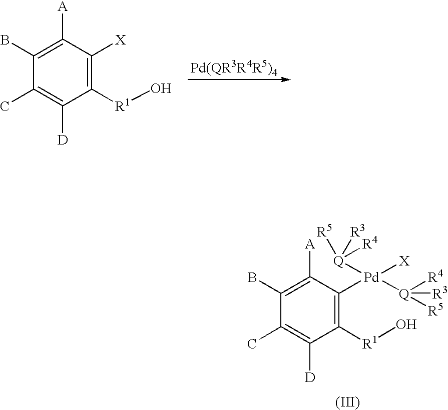

Suitable solvents for this reaction include polar aprotic solvents such tetrahydrofuran, dioxane, diethyl ether and non-polar organic solvents such as toluene and petroleum ethers. The reaction can be carried out at room temperature or at elevated temperatures, e.g. from 50-90° C. The reaction should be carried out in an inert atmosphere, e.g. under nitrogen, to prevent significant decomposition during the reaction.

Compounds of formula 2III may be prepared by reaction of a compound of formula III with a strong base such as sodium hydride or metal alkoxides.

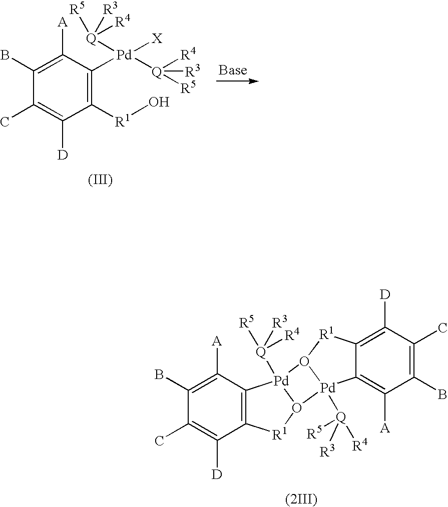

Suitable solvents include polar aprotic solvents such as THF. The reaction may suitable be carried out at room temperature. Suitably the reaction is carried out in an inert atmosphere, e.g. under nitrogen.

The solvent used in the present invention is suitably the source of the nucleophile, and is preferably an alcohol, (e.g. methanol), an amine or water. Alternatively, a non reactive co-solvent such as toluene can be used in combination with a nucleophilic reagent such as an alcohol, an amine or water. The catalytic reaction is suitably carried out at room temperature or above, e.g. 20-90° C. The catalytic reaction can be carried out under pressure in a vessel such as an autoclave which is pressurised with CO. Alternatively the catalytic reaction can be carried out at atmospheric pressure in a vessel such as a glass reactor wherein CO is bubbled through the reactor. The amount of catalyst required for one mole of reactant is suitably 0.00001 to 0.1 mole, preferably 0.001-0.05 mole.

When the carbonylation process is complete the catalyst can be recycled. The catalyst can be isolated from the reaction mixture and re-used, or additional reagents can be added to the reaction mixture.

In a particular embodiment of the invention, the compounds of formula I, 2I, II, 2II, III or 3III are attached to solid supports. The solid support is preferably a hydrocarbon resin in the form of beads or fibres. The compounds are suitably attached to the support via the ligands R³, R⁴ or R⁵, or via the groups A-D. Alternatively, the compounds may be ion exchanged onto a suitable support if ionising functional groups are present. A major advantage of attaching the compounds to solid supports is the ease of recovery of the catalyst for re-use. Additionally, the risk of contamination of the product by palladium is reduced and the loss of valuable palladium metal is reduced.

Whilst compound IIIB has been disclosed by Fernández-Rivas et al (Organometallics, 2001, 20 2998-3006) as an intermediate in the synthesis of palladacycle dimer A (see introduction), there is no suggestion that compounds IIIA and IIIB can be used as catalysts. Similarly, whilst compound 2IIIA is the same as dimer A as disclosed by Paz Muñoz et al., it has not previously been disclosed that this compound can be used in a catalytic carbonylation process, nor would it be apparent that this compound might be useful in an application such as this.

The invention will now be described by reference to examples which are not intended to be limiting of the invention:

### EXAMPLE 1

### Synthesis of Compound IA

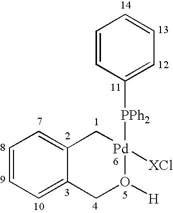

(2-Chloromethyl-phenyl)-methanol (0.25 g, 1.43 mmol) was dissolved in toluene (10 cm³), and added dropwise to a stirred suspension of tetrakis(triphenylphosphine)palladium(0) (1.65 g, 1.43 mmol) in toluene (60 cm³). The suspension was degassed and purged with N₂. The mixture was stirred at room temperature for 12 hours, and then filtered. The solid product was washed with diethyl ether (3×20 cm³) and dried in vacuo to give compound IA as an amorphous, off-white solid (570 mg, 76%), this was then recrystallised from dichloromethane and petroleum ether to give pale yellow cubes, mp 192-197° C. (decomp.) (Found: C, 59.16; H, 4.54%. C₂₆H₂₄ClOPPd requires C, 59.45; H, 4.60%); NMR assignments made by HMQC, NOE, DEPT, δ_{H} [CDCl₃] 2.70 (bs, 2H, H-1a,1b), 4.45 (bs, 2H, H-4a,4b), 6.20 (1H, d, J_{H-7,8}=7.70 Hz, H-7), 6.9-7.1 (m, 3H, H-8 or 9 or 10), 7.2-7.8 (m, 15H, PPh₃); δ_{C} [CDCl₃] 30.58 (C-1), 63.60 (C-4), 124.72 (C-8 or 9 or 10), 127.57 (C-7), 127.59, (C-8 or 9 or 10), 128.49 (PPh₃-C), 128.53 (PPh₃-C), 128.74, (C-8 or 9 or 10), 130.58, (PPh₃-C), 130.82 (PPh₃-ipso 4° C.), 134.48 (PPh₃-C), 134.6 (PPh₃-C), 139.07 (C-2 or C-3), 141.45 (C-2/C-3); δ_{P} [CDCl_{3] 41.38} (s); m/z Electrospray 525 (5.7%) (2M−Cl)*⁺, 1013 (100), C₂₆H₂₄ClOPPd requires 524; X-ray data, (C-1-Pd, 2.057 Å), (O—Pd, 2.1502 Å), (P—Pd, 2.2105 Å), (C1-Pd, 2.4081 Å).

### EXAMPLE 2

### Synthesis of Compound IB

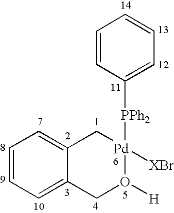

(2-Bromomethyl-phenyl)-methanol (0.25 g, 1.24 mmol) was dissolved in toluene (10 cm³), and added dropwise to a stirred suspension of tetrakis(triphenylphosphine)palladium(0) (1.43 g, 1.24 mmol) in toluene (60 cm³). The suspension was degassed and purged with N₂. The mixture was stirred at room temperature for 12 hours, and then filtered. The solid product was washed with diethyl ether (3×20 cm³) and dried in vacuo to give compound IB as an amorphous, off-white solid (605 mg, 86%), this was then recrystallised from dichloromethane and petroleum ether to give yellow cubes, mp 168-171° C. (decomp.) (Found: C, 54.96; H, 4.28%; C₂₆H₂₄BrOPPd requires C, 54.81; H, 4.28%); NMR assignments made by HMQC, NOE, DEPT, δ_{H} [CDCl₃] 2.80 (2H, d, ³J_{H-1a,1b-}³¹_{P}=2.5 Hz), 4.55 (bs, 2H, H-4), 6.15 (1H, d, J_{H-7,8}=7.68 Hz, H-7), 7.0 (m, 3H, H-8 or 9 or 10), 7.40-7.55 (m, 6H, PPh₃), 7.60-7.70, (m, 9H, PPh₃); δ_{C} [CDCl₃] 30.91 (C-1), 64.18 (C-4), 124.89 (C-8 or 9, or 10), 127.65 (C-7), 127.75, (C-8 or 9 or 10), 128.39 (PPh₃-C), 128.54 (PPh₃-C), 128.64, (C-8 or 9 or 10), 130.41, (PPh₃-C), 131.0 (PPh₃-ipso 4° C.), 134.26 (PPh₃-C), 134.47 (PPh₃-C), 138.9 (C-2 or C-3), 141.05 (C-2/C-3); δ_{P} [CDCl₃] 42.61 (s); m/z Electrospray (2M−⁷⁹Br)*⁺, 1058 (47%) C₂₆H₂₄BrOPPd requires 568; X-ray data, (C-1-Pd, 2.066 Å), (O—Pd, 2.124 Å), (P—Pd, 2.194 Å), (C₁-Pd, 2.5055 Å).

### EXAMPLE 3

### Synthesis of Compound 2IA

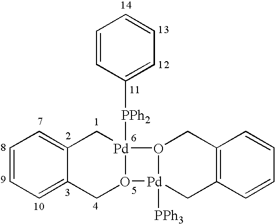

Compound IA (790 mg, 1.51 mmol) and triphenylphosphine (435 mg, 1.65 mmol) were suspended in THF (40 cm³). Solid NaH (60% by mass) (60 mg, 1.51 mmol) was added to the suspension, the vessel was quickly evacuated and re-filled with dry nitrogen. The suspension was stirred at room temperature for 12 hours. The liberation of hydrogen gas was observed. A pale green precipitate was removed by filtration, and the solid washed with H₂O (3×30 cm³) to remove NaCl, and with diethyl ether (3×10 ml), then dried in vacuo to give 2IA as a fine, pale green solid (570 mg, 77%), this was then recrystallised from dichloromethane and petroleum ether to pale yellow crystals, (Found: C, 62.64; H, 4.92%. C₅₂H₄₆O₂P₂Pd₂.H₂O requires C, 62.72; H, 4.86%); NMR assignments made by HMQC, NOE, DEPT, δ_{H} [CDCl₃] 2.36 (d, ³J_{H-1a,1b-}³¹_{P}=5.36 Hz, 4H), 3.34 (d, ³J_{H-4a,4a}³¹_{P}=4.15 Hz, 4H, H), 6.18-6.2 (m, 2H, H-10), 6.26-6.29 (m, 2H, H-7), 6.69-6.76 (m, 4H, H-8 or 9), 7.42-7.50 (m, 18H, PPh₃), 7.82-7.89 (m, 12H, PPh₃); δ_{C} [CDCl₃] 25.58, (C-1), 68.19 (C-4), 122.85 (C-8 or 9), 126.0 (C-7), 126.6 (C-8 or 9), 127.1 (C-10), 128.49 (PPh₃-C), 130.28 (PPh₃-C), 131.1 (d, J=46.62 Hz PPh₃-ipso 4° C.-P), 134.79 (PPh₃-C), 143.78 (C-2/3), 146.91 (C-2/3); δ_{P} [CDCl₃] 39.65 (s); m/z Electrospray M+(23=Na) 999 (83.63%), 476 (55.31%) C₅₂H₄₆O₂P₂Pd₂ requires 976; X-ray data, (C-1-Pd, 2.042 Å), (O—Pd, 2.083 Å), (P—Pd, 2.228 Å), (O—Pd, 2.128 Å)

### EXAMPLE 4

### Carbonylation of Benzyl Bromide Using Compound IB as a Catalyst

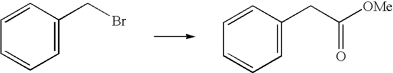

Benzyl bromide (7.6 g, 44.4 mmol), ethyldiisopropylamine (11.3 g, 88.8 mmol), triphenylphosphine (231 mg, 0.88 mmol), methanol (37.5 cm³), and compound IB (240 mg, 0.42 mmol) were added to a Parr autoclave. The vessel was pressurized to 3.45 bar with carbon monoxide and then vented; this procedure was repeated three times. The vessel was then pressurized again to 3.45 bar, and heated on the slow heating rate, with mechanical stirring at 1000 RPM. CO uptake was evident at 28° C., and the uptake halted at 47° C., at which time, the reaction was deemed complete. The heat source was removed, and the mixture allowed to cool to room temperature using the internal cooling coil. Any remaining gas pressure was vented. The product was a homogeneous orange liquid. G.C. analysis showed 99% conversion to methyl phenyl acetate. There was no G.C. evidence for the formation of benzyl methyl ether. The solvent was removed in vacuo, and the crude mixture flash chromatographed on silica gel, diethylether eluant (R^{f}=1.) The solvent was removed from the product containing fractions, and the residue vacuum-distilled to afford methyl phenyl acetate as a colourless liquid. The product was identical (IR, ¹H NMR) with an authentic sample.

### EXAMPLE 5

### Carbonylation of Benzyl Bromide Using Compound IB as a Catalyst

The reaction of Example 4 was repeated using atmospheric pressure conditions. Benzyl bromide (0.15 cm³, 1.24 mmol), ethyldiisopropylamine (0.24 g, 1.37 mmol), triphenylphosphine (32.5 mg, 0.124 mmol), methanol (20 cm³) and compound IB (35 mg, 0.062 mmol) were added to glass reactor. CO was introduced via a sinter to produce a stream of fine bubbles. The reactor was placed in a water bath heated to 60° C. The mixture was allowed to carbonylate for 120 minutes at this temperature. After the reaction time, the mixture was allowed to cool to room temperature. G.C.M.S analysis showed 99% conversion to methylphenylacetate and 1% conversion to benzyl methyl ether. The solvent was removed from the crude reaction mixture and the residue flash chromatographed (silica gel, diethylether eluant (R^{f}=1.) The solvent was removed from the product containing fractions, and the residue vacuum-distilled to afford methylphenyl acetate as a colourless liquid. The product was identical (IR, ¹H and ¹³C NMR) with an authentic sample.

### EXAMPLE 5a

### Repetitive Carbonylation of Benzyl Bromide Using Compound IB as a Catalyst

The reaction of Example 5 was repeated except after 60 minutes at 60° C. the reactor was allowed to cool to room temperature to produce an orange-coloured mixture. The cooled reactor was then recharged with additional benzyl bromide (0.15 cm³, 1.24 mmol), ethyldiisopropylamine (0.24 g 1.37 mmol) and triphenylphosphine (3.25 mg, 0.124 mmol) in methanol (20 cm³), CO was bubbled through the mixture and the reactor reheated to 60° C. for a further 60 minutes. G.C.M.S. analysis of the cooled mixture showed 99% conversion of the combined amount of benzyl bromide to methylphenylacetate and 1% conversion to benzyl methyl ether.

### COMPARATIVE EXAMPLE 1

### Carbonylation of Benzyl Bromide Using (PPh₃)₂PdCl₂ as a Catalyst

Example 5 was repeated except that (PPh₃)₂PdCl₂ (a mixture of PdCl₂ and PPh₃; 88% PPh₃ by mass) was used as the catalyst and the reaction was carried out at 72° C. G.C.M.S. analysis showed 86% conversion of starting material, giving 74% methylphenylacetate and 12% benzyl methyl ether.

### EXAMPLE 6

### Carbonylation of 1-bromomethyl-4-methylbenzene Using Compound IB as Catalyst

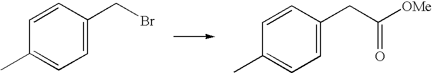

1-Bromomethyl-4-methylbenzene (8.22 g, 44.4 mmol), ethyldiisopropylamine (11.3 g, 88.8 mmol), triphenylphosphine (576.4 mg, 2.2 mmol), methanol (37.5 cm³) and compound IB (252 mg, 0.44 mmol) were reacted following the method of Example 4. G.C. analysis showed 93% conversion to methyl para tolyl acetate, 7% benzyl methyl ether. The product, a colourless liquid, was identical (IR, ¹H NMR) with an authentic sample.

### COMPARATIVE EXAMPLE 2

### Carbonylation of 1-bromomethyl-4-methylbenzene Using (PPh₃)₂PdCl₂ as a Catalyst

Example 6 was repeated except that (PPh₃)₂PdCl₂ (311 mg, 0.44 mmol) was used as the catalyst. G.C.M.S. analysis showed 59% conversion to methyl para tolyl acetate with 36% conversion to 1-methoxymethyl-4-methyl-benzene and 5% unreacted 1-bromomethyl-4-methyl-benzene.

### EXAMPLE 7

### Carbonylation of ortho-xylylene-α,α′-dibromide Using Compound IB as Catalyst

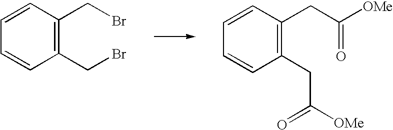

ortho-Xylylene-α,α′-dibromide (327.4 mg, 1.24 mmol), ethyldiisopropylamine (0.48 g, 2.74 mmol), triphenylphosphine (32.5 mg, 0.124 mmol), methanol (20 cm³) and compound IB (35 mg, 0.062 mmol) were reacted following the method of Example 5 except that the water bath was heated to 55° C. G.C.M.S analysis showed quantitative conversion to (2-methoxycarbonylmethyl-phenyl)-acetic acid methyl ester. The product, a colourless liquid, was identical (IR, ¹H and ¹³C NMR) with an authentic sample.

### EXAMPLE 8

### Carbonylation of 2-bromomethylnaphthalene to Form naphthalen-2-yl-acetic acid methyl ester Using Compound IA as Catalyst

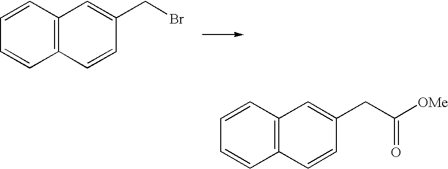

2-Bromomethylnaphthalene (274.2 mg, 1.24 mmol), ethyldiisopropylamine (0.24 cm³, 1.37 mmol), triphenylphosphine (32.5 mg, 0.124 mmol), methanol (20 cm³), and compound IA (32.52 mg, 0.062 mmol) were reacted following the method of Example 5. During the course of the reaction, the colour of the solution changed from virtually colourless to deep orange. G.C.M.S. analysis showed 98% conversion to naphthalen-2-yl-acetic acid methyl ester. There was no G.C. evidence for the formation of 2-methoxymethyl-naphthalene. The product was identical (IR, ¹H NMR) with an authentic sample.

### EXAMPLE 9

### Carbonylation of ortho-bromomethyl benzyl Alcohol to Form 3-isochromanone Using Compound 21A as Catalyst

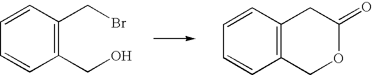

ortho-Bromomethyl benzyl alcohol (0.25 g, 1.24 mmol), ethyldiisopropylamine (0.24 ml, 1.37 mmol), triphenylphosphine (16.24 mg, 0.06 mmol), toluene (20 cm³) and compound 2IA (12.14 mg, 0.0124 mmol) were reacted according to the method of Example 5, except that the mixture was allowed to carbonylate for 130 minutes. During the course of the reaction, the colour of the solution changed from virtually colourless to deep orange to yellow. G.C.M.S. analysis showed that ortho-bromomethyl benzyl alcohol had been completely consumed, to give 3-isochromanone quantitatively. Crystals of 3-isochromanone appeared in the product mixture upon standing, due to low solubility in toluene.

### EXAMPLE 10

### Synthesis of Compound IIA

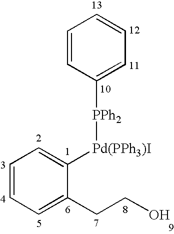

2-(2-Iodo-phenyl)-ethanol (0.75 g, 3.03 mmol) was dissolved in toluene (20 cm³), and added dropwise to a stirred suspension of tetrakis(triphenylphosphine)palladium(0) (3.50 g, 3.03 mmol) in toluene (150 cm³). The suspension was degassed and purged with N₂. The mixture was stirred at room temperature for 12 hours. The mixture was refrigerated to aid crystallisation. The resultant precipitate was filtered under nitrogen and washed with diethyl ether (3×20 cm³) and dried in vacuo to give compound IIA as a white solid (1.135 g, 43%), this was then recrystallised from dichloromethane and petroleum ether to give colourless needles. (Found: C, 55.52; H, 4.27%. C₄₄H₃₉IOP₂Pd.dichloromethane requires C, 56.07; H, 4.29%); NMR assignments made by DEPT, δ_{H} [CDCl₃] 0.04 (t, ²J_{H-9,H-8}=6.03 Hz 1H, H-9), 2.58 (t, ²J_{H-7,H-8}=6.76 Hz, 2H, H-7), 3.27 (pseudo q, J_{H-8,H-9}=6.03 Hz, ²J_{H-8,H-7}=6.76 Hz, 2H, H-8), 6.23-6.30 (bd, J=7.5 Hz, 1H, H-2 or 3 or 4 or 5), 6.35-6.40 (t, J=7.06 Hz, 1H, H-2 or 3 or 4 or 5), 6.55-6.61 (t, J=7.06 Hz, 1H, H-2 or 3 or 4 or 5), 6.88-7.05 (m, 1H, H-2 or 3 or 4 or 5), 7.20-7.27 (m, 12H, PPh₃), 7.30-7.35 (m, 6H, PPh₃), 7.39-7.47 (m, 12H, PPh₃); δ_{C} [CDCl₃] 42.22 (C-7), 61.42, (C-8), 123.23 (C-2 or 3 or 4 or 5), 124.78 (C-2 or 3 or 4 or 5), 127.81 (C-11 or 12), 129.41 (C-2 or 3 or 4 or 5), 129.89 (C-13), 131.92 (t, J=0.23 Hz C-10-P), 134.92 (C-11 or 12), 135.97 (C-2 or 3o or 4 or 5), 141.39 (C-1 or 6), 159.65 (C-1 or 6); δ_{P} [CDCl₃] δ=23.16, (s); m/z Electrospray 751.3 (M−I=127) C₄₄H₃₉IOP₂Pd requires 879.

### EXAMPLE 11

### Synthesis of Compound 2IA

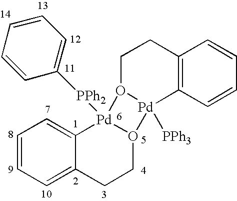

Compound IIA (222 mg, 0.360 mmol) and triphenylphosphine (103.9 mg, 0.396 mmol) were suspended in THF (20 cm³). Solid NaH (60% by mass) (23.76 mg, 0.396 mmol) was added to the suspension, the vessel was quickly evacuated and re-filled with dry nitrogen. The suspension was stirred at RT for 12 hours. The liberation of hydrogen gas was observed. A pale green precipitate was removed by filtration, and the solid washed with H₂O (3×5 cm³) to remove NaCl, and with diethyl ether (3×10 ml), then dried in vacuo to give Compound 2IA as a fine, pale green solid (100 mg, 57%), this was then recrystallised from dichloromethane and petroleum ether to colourless cubes; (Found: C, 63.68; H, 5.28%. C₅₂H₄₆O₂P₂Pd₂ requires C, 63.88; H, 4.74%); NMR assignments made by DEPT, δ_{H} [CDCl₃] 2.70 (bd, 8H, H-3,4), 6.21 (dt, J_{H-7,H-8}=7.35 Hz, J_{H-7,H-10}=1.62 Hz, 2H, H-7), 6.52-6.61 (m, 6H, H-8, 9, 10), 7.13-7.21 (m, 12H, PPh₃), 7.28-7.34 (m, 6H, PPh₃), 7.49-7.56 (m, 12H, PPh₃); δ_{C} [CDCl₃] 48.0 (C-3), 65.21 (C-4), 122.68 (C-7 or 8 or 9 or 10), 123.21 (C-7 or 8 or 9 or 10), 125.28 (C-7 or 8 or 9 or 10), 128.10 (C-12 or 13), 130.11 (C-14), 131.63 (d, J=47 Hz C11-P), 134.64 (C-12 or 13), 138.15 (C-7 or 8 or 9 or 10), 141.08 (C-1 or 2), 146.76 (C-1 or 2); δ_{P} [CDCl₃] 35.56 (s); m/z Electrospray 978 (M+1) C₅₂H₄₆O₂P2Pd₂ requires 977.

### EXAMPLE 12

### Carbonylation of 1-bromomethyl-4-methylbenzene Using Compound IIA as a Catalyst

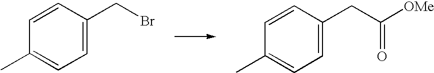

1-Bromomethyl-4-methylbenzene (230 mg, 1.24 mmol), ethyldiisopropylamine (0.24 g, 1.37 mmol), triphenylphosphine (32.5 mg, 0.124 mmol), methanol (20 cm³) and compound IIA (55 mg, 0.062 mmol) were added to glass reactor. CO was introduced via a sinter to produce a stream of fine bubbles. The reactor was placed in a water bath heated to 60° C. The mixture was allowed to carbonylate for 120 minutes at this temperature. After the reaction time, the mixture was allowed to cool to room temperature. G.C.M.S analysis showed quantitative conversion to para-tolyl-acetic acid methyl ester. The solvent was removed from the crude reaction mixture and the residue flash chromatographed (silica gel, diethylether eluant). The solvent was removed from the product containing fractions, and the residue vacuum-distilled to afford methyl para-tolyl acetate as a colourless liquid. The product was identical (IR, ¹H and ¹³C NMR) with an authentic sample.

### COMPARATIVE EXAMPLE 3

### Carbonylation of 1-bromomethyl-4-methylbenzene Using (PPh₃)₂PdCl₂ as a Catalyst

Example 12 was repeated except that (PPh₃)₂PdCl₂_{_{—}}(311 mg, 0.44 mmol) was used as the catalyst. G.C.M.S. analysis showed 59% conversion to methyl para-tolyl acetate, with 36% conversion to 1-methoxymethyl-4-methyl-benzene and 5% unreacted 1-bromomethyl-4-methyl-benzene.

### EXAMPLE 13

### Carbonylation of Benzyl Bromide Using Compound 2IA as a Catalyst

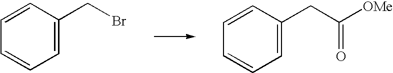

Benzyl bromide (0.15 cm³, 1.24 mmol), ethyldiisopropylamine (0.24 g, 1.37 mmol), triphenylphosphine (32.5 mg, 0.124 mmol), methanol (20 cm³) and compound 2IA (30.3 mg, 0.031 mmol) were reacted according to the method of Example 12. G.C.M.S analysis showed quantitative conversion to methyl phenyl acetate. The product was identical (G.C, ¹H and ¹³C NMR) with an authentic sample.

### EXAMPLE 14

### Carbonylation of 2-nitro benzyl bromide Using Compound 2IIA as a Catalyst

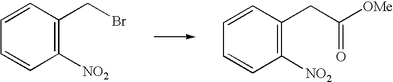

2-Nitro-benzyl bromide (268 cm³, 1.24 mmol), ethyldiisopropylamine (0.24 g, 1.37 mmol), triphenylphosphine (32.5 mg, 0.124 mmol), methanol (20 cm³) and compound 2IA (30.3 mg, 0.031 mmol) were reacted according to the method of Example 12. G.C.M.S analysis showed 98% conversion to methyl 2-nitrophenyl acetate and 1% conversion to 2-nitrotoluene. The product was identical (G.C, ¹H-NMR) with an authentic sample.

### Synthesis of Compound IIIA

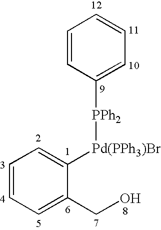

2-Bromobenzyl alcohol (0.25 g, 1.34 mmol) was dissolved in toluene (10 cm³), and added dropwise to a stirred suspension of tetrakis(triphenylphosphine)palladium(0) (1.54 g, 1.34 mmol) in toluene (60 cm³). The suspension was degassed and purged with N₂. The mixture was stirred at 70° C. for 48 hours. Approximately one third of the solvent was removed in vacuo and replaced with 40 ml petroleum ether. The mixture was refrigerated to aid crystallisation. The resultant precipitate was filtered under nitrogen and washed with diethyl ether (3×20 cm³) and dried in vacuo to give compound IIIA as a yellowish solid (627 mg, 57%), this was then recrystallised from dichloromethane and petroleum ether to give yellow crystals; mp. 265° C. (decomp.); (Found: C, 58.35; H, 4.27%. C₄₃H₃₇BrOP₂Pd.dichloromethane requires C, 58.53; H, 4.35%); NMR assignments made by NOE, DEPT, δ_{H} [CDCl₃] 0.04 (t, ²J_{H-8, H-7a,7b}=6.91 Hz 1H, H-8), 4.16 (d, ²J_{H-7a,7b-H-8},=6.63 Hz 2H, H-7), 6.38-6.48 (m, 2H, H-3, H-4), 6.62 (t, J=7.34 Hz, 1H, H-2 or 5), 7.01-7.05 (m, 1H, H-2 or 5), 7.21-7.25 (m, 12H PPh₃), 7.30-7.38 (m, 6H PPh₃), 7.40-7.48 (m, 12H, PPh₃); δ_{C} [CDCl₃] 68.60, (C-7), 123.37 (C-2 or 3 or 4 or 5), 125.73 (C-2 or 3 or 4 or 5), 128.03 (C-10 or 11), 128.10 (C-2 or 3 or 4 or 5), 130.0 (C-12), 131.0 (C-9), 134.33 (C-2 or 3 or 4 or 5), 134.52 (C-10 or 11), 144.07 (C-1 or 6), 155.67 (C-1 or 6); δ_{P} [CDCl₃] δ=24.75, (s); m/z Electrospray 736 (M−Br 79) (100%), C₄₃H₃₇BrOP₂Pd requires 818.

### Synthesis of Compound IIIB

2-Iodobenzyl alcohol (0.5 g, 2.14 mmol) was dissolved in toluene (20 cm³), and added dropwise to a stirred suspension of tetrakis(triphenylphosphine)palladium(0) (2.47 g, 2.14 mmol) in toluene (80 cm³). The suspension was degassed and purged with N₂. The mixture was stirred at room temperature for 12 hours. Approximately one third of the solvent was removed in vacuo and replaced with 30 ml petroleum ether. The mixture was refrigerated to aid crystallisation. The resultant precipitate was filtered under nitrogen and washed with diethyl ether (3×20 cm³) and dried in vacuo to give compound IIIB as a yellowish solid (1.13 g, 61%), this was then recrystallised from dichloromethane and petroleum ether to give yellow crystals. (Found: C, 55.32; H, 4.07%. C₄₃H₃₇IOP₂Pd.dichloromethane requires C, 55.60; H, 4.14%); NMR assignments made by NOE, DEPT, δ_{H} [CDCl₃] 0.00 (t, ²J_{H-8, H-7a,7b}=6.91 Hz 1H, H-8), 4.18 (d, J_{H-7a,7b-H-8}, =6.91 Hz 2H, H-7), 6.40-6.48 (m, 2H, H-3, H-4), 6.62 (t, J=7.35 Hz, 1H, H-2 or 5), 7.05-7.08 (m, 1H, H-2 or 5), 7.21-7.25 (m, 12H PPh₃), 7.30-7.38 (m, 6H PPh₃), 7.40-7.48 (m, 12H, PPh₃); δ_{C} [CDCl₃] 68.19, (C-7), 123.53 (C-2 or 3 or 4 or 5), 125.72 (C-2 or 3 or 4 or 5), 127.91 (C-10 or 11), 128.38 (C-2 or 3 or 4 or 5), 130.00 (C-12), 131.77 (C-9), 134.04 (C-2 or 3 or 4 or 5), 134.85 (C-10 or 11), 144.19 (C-1 or 6), 158.37 (C-1 or 6); δ_{P} [CDCl₃] δ=23.75, (s); m/z Electrospray 737.2 (M−I=127) C₄₃H₃₇IOP₂Pd requires 865.

### EXAMPLE 15

### Carbonylation of Benzyl Bromide Using Compound IIIa as a Catalyst

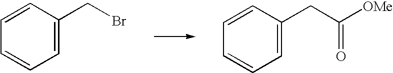

Benzyl bromide (0.148 cm³, 1.24 mmol), ethyldiisopropylamine (0.24 cm³, 1.37 mmol), triphenylphosphine (32.5 mg, 0.124 mmol), methanol (20 cm³), and compound IIIA (50.65 mg, 0.062 mmol) were added to glass reactor. Carbon monoxide was introduced via a sinter to produce a stream of fine bubbles. The reactor was placed in a water bath heated to 60° C. The mixture was allowed to carbonylate for 120 minutes at this temperature. During the course of the reaction, the colour of the solution changed from virtually colourless to yellow. After the reaction time, the mixture was allowed to cool to room temperature. G.C.M.S. analysis showed 99% conversion to methylphenyl acetate and a trace amount of benzylmethyl ether. The solvent was removed in vacuo, and the crude mixture flash chromatographed on silica gel, diethylether eluant. The solvent was removed from the product containing fractions, to give methylphenyl acetate. The product was identical (IR, ¹H NMR) with an authentic sample.

### EXAMPLE 16

### Carbonylation of Benzyl Bromide Using Compound IIIB as a Catalyst

Example 15 was repeated using compound IIIB (50 mg, 0.062 mmol) as the catalyst. G.C.M.S analysis showed 99% conversion to methylphenylacetate and 1% conversion to benzyl methyl ether. The product was identical (IR, ¹H and ¹³C NMR) with an authentic sample.

### COMPARATIVE EXAMPLE 4

### Carbonylation of Benzyl Bromide Using (PPh₃)₂PdCl₂ as a Catalyst

Example 15 was repeated except that (PPh₃)₂PdCl₂ (a mixture of PdCl₂ and PPh₃; 88% PPh₃ by mass) was used at the catalyst and the reaction was carried out at 72° C. G.C.M.S. analysis showed 86% conversion of starting material, giving 74% methylphenylacetate and 12% benzyl methyl ether.

### EXAMPLE 17

### Carbonylation of 2-iodobenzyl Alcohol to Form 3H-isobenzofuran-1-one Using Compound 2IIIA as a Catalyst

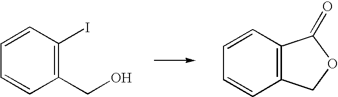

2-iodobenzyl alcohol (0.5 g, 2.14 mmol), ethyldiisopropylamine (0.74 ml, 4.58 mmol), triphenylphosphine (28.04 mg, 0.11 mmol), toluene (20 cm³) and compound 2IIIA (10.14 mg, 0.0107 mmol) were added to glass reactor. Carbon monoxide was introduced via a sinter to produce a stream of fine bubbles. The reactor was placed in a water bath heated to 60° C. The mixture was allowed to carbonylate for 100 minutes at this temperature. During the course of the reaction, the colour of the solution changed from virtually colourless to deep purple. After the reaction time, the mixture was allowed to cool to room temperature, and analysed by G.C.M.S. 2-iodobenzyl alcohol had been completely consumed, to give 3H-isobenzofuran-1-one quantitatively.

As can be seen from the examples described, carbonylation reactions carried out using the improved catalysts overcome many of the problems and drawbacks associated with the prior art. For example, the improved catalysts are selective, thus increasing the percent yield of the desired product. In addition, the improved catalysts generally produce a product that does not contain any significant amount of starting material, again improving the percent yield. This eliminates the need for purification as the products of these reactions are the pure desired products. As purification is time-consuming and expensive, and can be environmentally unfriendly and labour intensive, the advantages of using the catalysts of the present invention are apparent. This is especially the case when purification is carried out on an industrial scale.

It is also apparent that the catalysts of the present invention can be used at relatively low temperature and at atmospheric pressure, making these reactions less complex to carry out on an industrial scale. This is especially the case when using carbon monoxide (CO) gas, which is often used in carbonylation processes. Maintaining these reaction conditions is therefore less expensive than those as described in the prior art, as they do not require heat input or a pressurised reaction vessel.

In addition, due to the mild conditions that can be used, the catalysts and catalytic process of the present invention will better retain functional groups that do not withstand harsh conditions. Therefore the catalysts and catalytic processes of the present invention have a greater number of applications than those as described in the prior art.

1.-70. (canceled)

71. A palladium compound of formula I: 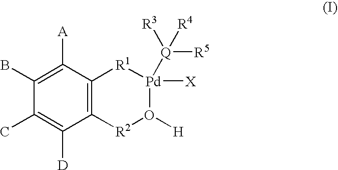
wherein
A, B, C and D are independently selected from the group consisting of H, alkyl, aryl, alkenyl, halo, alkoxy, dialkylamino, nitro, and carbonyl-containing groups, or taken together may form an aromatic ring which may be optionally substituted with H, alkyl, aryl, alkenyl, halo, alkoxy, dialkylamino, nitro, and carbonyl-containing groups;
R¹ and R² are independently chosen from an alkylene group that may be optionally substituted with alkoxy or carbonyl-containing group;
Q is P, As or Sb;
R³, R⁴ and R⁵ are independently chosen from aryl or alkyl that may be optionally substituted with alkyl, aryl, dialkylamino, and alkoxy or metal salts of sulfonic acid, carboxylic acid, and phosphonic acid; and
X is selected from the group consisting of halo, carboxylate, tosylate, mesylate, and triflate.

72. A compound according to claim 71, wherein A, B, C and D are each H, and R¹ and R² are CH₂.

73. A compound according to claim 71, wherein Q is P and R³, R⁴ and R⁵ are selected from the group consisting of phenyl, alkyl-substituted phenyl, and alkoxy-substituted phenyl.

74. A compound according to claim 71, having the formula IA or IB:

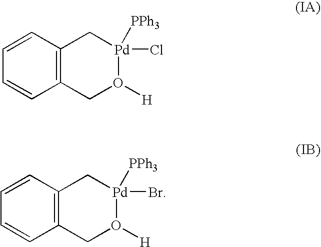

75. A compound according to claim 71, wherein said compound is attached to a solid support.

76. A palladium compound of formula 2I: 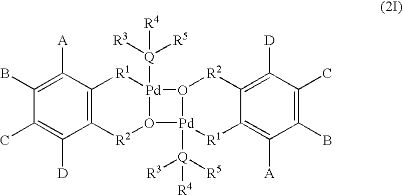
wherein
A, B, C and D are independently selected from the group consisting of H, alkyl, aryl, alkenyl, halo, alkoxy, dialkylamino, nitro, and carbonyl-containing groups, or taken together may form an aromatic ring which may be optionally substituted with H, alkyl, aryl, alkenyl, halo, alkoxy, dialkylamino, nitro, and carbonyl-containing group;
R¹ and R² are independently chosen from an alkylene group that may be optionally substituted with alkoxy or carbonyl-containing group;
Q is P, As or Sb; and
R³, R⁴ and R⁵ are independently chosen from aryl or alkyl that may be optionally substituted with alkyl, aryl, dialkylamino, and alkoxy or metal salts of sulfonic acid, carboxylic acid, and phosphonic acid.

77. A compound according to claim 76, wherein A, B, C and D are each H and R¹ and R² are CH₂.

78. A compound according to claim 76, wherein Q is P and R³, R⁴ and R⁵ are selected from the group consisting of phenyl, alkyl-substituted phenyl, and alkoxy-substituted phenyl.

79. A compound according to claim 76, having the formula 2IA:

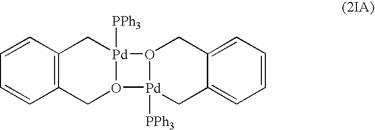

80. The compound according to claim 76, wherein said compound is attached to a solid support.

81. The palladium compound having the formula 2II: 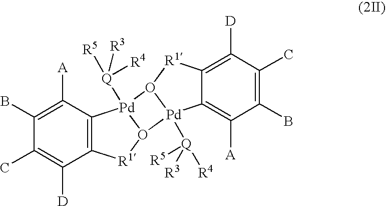
wherein
A, B, C and D are independently selected from the group consisting of H, alkyl, aryl, alkenyl, halo, alkoxy, dialkylamino, nitro, and carbonyl-containing groups, or taken together may form an aromatic ring which may be optionally substituted with H, alkyl, aryl, alkenyl, halo, alkoxy, dialkylamino, nitro, and carbonyl-containing group;
R^{1′} is an alkylene group that may be optionally substituted with alkoxy or carbonyl-containing group;
Q is P, As or Sb; and
R³, R⁴ and R⁵ are independently chosen from aryl or alkyl that may be optionally substituted with alkyl, aryl, dialkylamino, and alkoxy or metal salts of sulfonic, carboxylic, and phosphonic acid.

82. A compound according to claim 81, wherein A, B, C and D are each H, and R^{1′} is (CH₂)₂.

83. A compound according to claim 81, wherein Q is P and R³, R⁴ and R⁵ are selected from the group consisting of phenyl, alkyl-substituted phenyl, and alkoxy-substituted phenyl.

84. A compound according to claim 81, having the formula 2IIA:

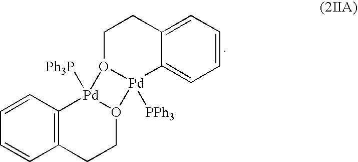

85. The compound according to claim 81, wherein said compound is attached to a solid support.

86. A palladium compound of formula II: 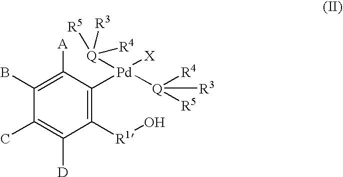
wherein
A, B, C and D are independently selected from the group consisting of H, alkyl, aryl, alkenyl, halo, alkoxy, dialkylamino, nitro, and carbonyl-containing groups, or taken together may form an aromatic ring which may be optionally substituted with H, alkyl, aryl, alkenyl, halo, alkoxy, dialkylamino, nitro, and carbonyl-containing group;
R^{1′} is an alkylene group that may be optionally substituted with alkoxy or carbonyl-containing group;
Q is P, As or Sb;
R³, R⁴ and R⁵ are independently chosen from aryl or alkyl that may be optionally substituted with alkyl, aryl, dialkylamino, and alkoxy or metal salts of sulfonic acid, carboxylic acid, and phosphonic acid; and
X is selected from the group consisting of halo, carboxylate, tosylate, mesylate, and triflate.

87. A compound according to claim 86, wherein A, B, C and D are each H, and R^{1′} is (CH₂)₂.

88. A compound according to claim 86, wherein Q is P and R³, R⁴ and R⁵ are selected from the group consisting of phenyl, alkyl-substituted phenyl, and alkoxy-substituted phenyl.

89. The palladium compound of claim 86, having the formula IIA:

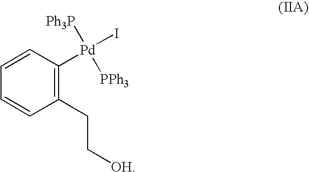

90. A catalytic process comprising:
forming a carbon-carbon bond or a carbon-heteroatom bond in a chemical moiety in the presence of a catalyst, said catalyst selected from the group consisting of 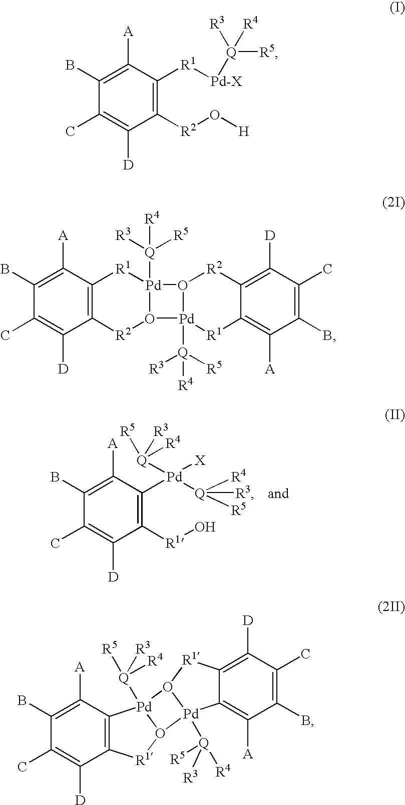
wherein
A, B, C and D are independently selected from the group consisting of H, alkyl, aryl, alkenyl, halo, alkoxy, dialkylamino, nitro, and carbonyl-containing groups, or taken together may form an aromatic ring which may be optionally substituted with H, alkyl, aryl, alkenyl, halo, alkoxy, dialkylamino, nitro, and carbonyl-containing groups;
R¹ and R² are independently chosen from an alkylene group that may be optionally substituted with alkoxy or carbonyl-containing group;
R^{1′} is an alkylene group that may be optionally substituted with alkoxy or carbonyl-containing group;
Q is P, As or Sb;
R³, R⁴ and R⁵ are independently chosen from aryl or alkyl that may be optionally substituted with alkyl, aryl, dialkylamino, and alkoxy or metal salts of sulfonic acid, carboxylic acid, and phosphonic acid; and
X is selected from the group consisting of halo, carboxylate, tosylate, mesylate, and triflate.

91. A process according to claim 90, wherein the forming step is carbonylating a compound R-Lg with carbon monoxide, wherein R is aryl or ArCR^{a}R^{b}; Ar is aryl or heteroaryl; R^{a} and R^{b} are independently chosen from the group consisting of H, alkyl and aryl; and Lg is a leaving group.

92. A process according to claim 90, wherein Lg is selected from the group consisting of halo, tosylate, mesylate, triflate, and carboxylate.

93. A process according to claim 90, wherein the forming step is additionally in the presence of nucleophile.

94. A process according to claim 90, wherein the amount of catalyst present is 0.00001 to 0.1 mole per one mole of reactant.

95. A process according to claim 90, wherein the catalyst is attached to a solid support.

96. A method for preparing a palladium compound of formula (I) 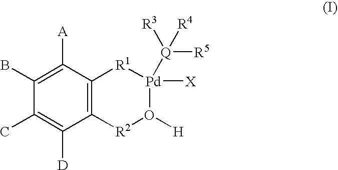
comprising:
reacting a benzyl alcohol derivative of formula 3I 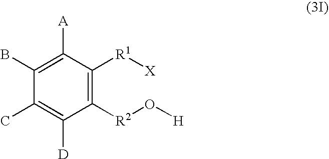
with a Pd(QR³R⁴R⁵), complex or with a mixture of QR³R⁴R⁵ and a Pd precursor complex, wherein
A, B, C and D are independently selected from the group consisting of H, alkyl, aryl, alkenyl, halo, alkoxy, dialkylamino, nitro, and carbonyl-containing groups, or taken together may form an aromatic ring which may be optionally substituted with H, alkyl, aryl, alkenyl, halo, alkoxy, dialkylamino, nitro, and carbonyl-containing group;
R¹ and R² are independently chosen from an alkylene group that may be optionally substituted with alkoxy or carbonyl-containing group;
Q is P, As or Sb; R³, R⁴ and R⁵ are independently chosen from aryl or alkyl that may be optionally substituted with alkyl, aryl, dialkylamino, and alkoxy or metal salts of sulfonic acid, carboxylic acid, and phosphonic acid; and
n is from 2 to 4.

97. A method for preparing a compound of formula 2I 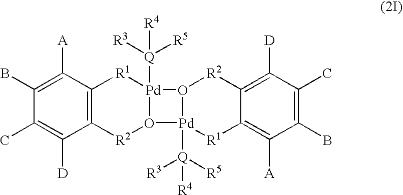
comprising:
reacting a compound of formula I 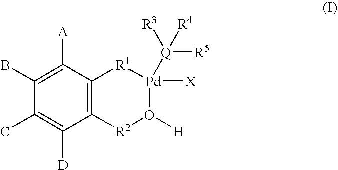
with a strong base.

98. A method for preparing a compound of formula II 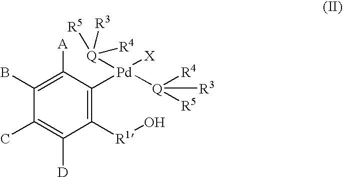
comprising reacting a benzyl alcohol derivative of formula 3Ii 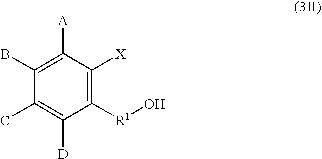
with a Pd(QR³R⁴R⁵), or a mixture of QR³R⁴R⁵ and a Pd precursor complex, wherein
A, B, C and D are independently selected from the group consisting of H, alkyl, aryl, alkenyl, halo, alkoxy, dialkylamino, nitro, and carbonyl-containing groups, or taken together may form an aromatic ring which may be optionally substituted with H, alkyl, aryl, alkenyl, halo, alkoxy, dialkylamino, nitro, and carbonyl-containing group;
R¹ is an alkylene group that may be optionally substituted with alkoxy or carbonyl-containing group;
Q is P, As or Sb;
R³, R⁴ and R⁵ are independently chosen from aryl or alkyl that may be optionally substituted with alkyl, aryl, dialkylamino, and alkoxy or metal salts of sulfonic acid, carboxylic acid, and phosphonic acid; and
n is from 2 to 4.

99. A catalytic process comprising:
forming a carbon-carbon bond or a carbon-heteroatom bond in a chemical moiety in the presence of a catalyst, said catalyst being a palladium compound of formula III: 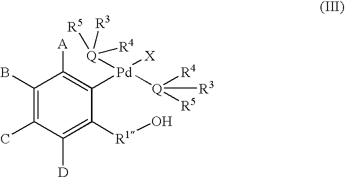
wherein
A, B, C and D are independently chosen from H, alkyl, aryl, alkenyl, halo, alkoxy, dialkylamino, nitro and carbonyl-containing groups, and a group wherein at least one of A and B, B and C, and C and D together form an aromatic ring optionally substituted with a substituent selected from the group consisting of H, alkyl, aryl, alkenyl, halo, alkoxy, dialkylamino, nitro and carbonyl-containing groups;
R^{1″} is an alkylene group that is optionally substituted with alkoxy or carbonyl-containing groups;
Q is selected from the group consisting of P, As and Sb;
wherein R³, R⁴ and R⁵ are independently chosen from aryl or alkyl groups that are optionally substituted with alkyl, aryl, dialkylamino, alkoxy or metal salts of sulfonic acid, carboxylic acid, and phosphonic acid; and
X is selected from the group consisting of halo, carboxylate, tosylate, mesylate and triflate.

100. A process according to claim 99, wherein A, B, C and D are each H, and R¹ is CH₂.

101. A process according to claim 99, wherein Q is P and R³, R⁴ and R⁵ are selected from the group consisting of phenyl, alkyl-substituted phenyl, and alkoxy-substituted phenyl.
